(19) United States
(12) Patent Application Publication
(10) Pub. No.: US 2001/0026365 A1
(43) Pub. Date: Oct. 4, 2001

(54) Evaluation of optically anisotropic structure

(76) Inventor: Ichiro Hirosawa, Tokyo (JP)

Correspondence Address: Whitham, Curtis & Whitham, Reston International Center, 11800 Sunrise Valley Dr., Suite 900, Reston, VA, 20191, US

(21) Appl. No.: 09/816,149

(22) Filed: Mar. 26, 2001

(30) Foreign Application Priority Data
Mar. 27, 2000 (JP) 086736/2000

(51) Int. Cl. G01J 4/00

(52) U.S. Cl. 356/369

(57) ABSTRACT

A method of evaluating an optically anisotropic structure is provided, which makes it possible to realize correct evaluation of the optical anisotropy of an optically anisotropic structure. This method comprises the steps of: (a) irradiating incident light containing a first polarized component to an optically anisotropic structure, generating reflected light containing a second polarized component due to reflection by the structure; the first polarized component being one of a s-polarized component and a p-polarized component; the second polarized component being one of a s-polarized component and a p-polarized component and different from the first polarized component; and (b) measuring intensity of the second polarized component of the reflected light, determining optical anisotropy of the structure When the structure is translated in the step (b), the in-plane distribution of optical anisotropy of the structure is measured. When the structure is turned in the step (b), the orientation of principal dielectric constant coordinate axes of the structure is determined.

### BACKGROUND OF THE INVENTION

1. Field of the Invention

The present invention relates to evaluation of an optically anisotropic structure and more particularly, to a method of evaluating an optically anisotropic structure, such as an alignment layer for aligning the initial orientation of liquid crystal molecules and an evaluation system used therefor.

2. Description of the Related Art

Conventionally, various evaluation techniques for evaluating an optically anisotropic layer or structure by irradiating incident light thereto and receiving its reflected light by the layer or structure have been developed

For example, the Japanese Non-Examined Patent Publication No. 3-65637 published in March 1991 discloses a method of measuring the refractive index of an optically anisotropic multilayer structure, which was invented by T. Isobe. In this method, incident light is irradiated to an optically anisotropic multilayer structure to generate reflected light by the structure. Then, the intensity of the reflected light is measured The refractive index and the thickness of the uppermost layer of the structure is found on the basis of the fact that the intensity of the reflected light varies dependent on the incidence angle of the incident light and the incidence orientation thereof.

The Japanese Non-Examined Patent Publication No. 9-218133 published in August 1997 (Japanese Patent Application No. 8-49320 filed on Mar. 6, 1996) discloses a method of evaluating an optically anisotropic layer, which was invented by I. Hirosawa. In this method, incident light is irradiated to a sample of an optically anisotropic layer to generate reflected light by the layer while the sample is subjected to in-plane turning. Then, the polarization state of the reflected light is measured. The dielectric constant, the thickness, and the direction of the principal dielectric constant coordinate axes of the aligned part of the sample, and the dielectric constant and the thickness of the unaligned part thereof.

The Japanese Non-Examined Patent Publication No. 7-151640 published in June 1995 discloses an evaluation system of an optically anisotropic layer, which was invented by T. Ishihara et al.. In this system, two linearly polarized light perpendicular to each other is generated from incident infrared light and then, they are irradiated to an optically anisotropic layer. The absorption of the reflected light is measured. Thus, the difference between the two linearly polarized reflected light (i.e., infrared dichromatic difference) is calculated.

The Japanese Non-Examined Patent Publication No. 5-5699 published in January 1993 discloses a method of measuring the refractive index and the thickness of an optically anisotropic layer, which was invented by T. Isobe. In this method, incident visible light is irradiated to an optically anisotropic layer while the incidence angle of the incident light is changed.

With the above-described conventional methods or system disclosed in the Publication Nos. 3-65637, 9-218133, 7-151640, and 5-5699, the orientation of crystal, which is equivalent to the orientation of molecules, for an inorganic material layer with high crystallinity can be evaluated quantitatively. This is because the correlation between the crystal structure and the optical anisotropy has been often clarified. However, there is a disadvantage that the measurable area of the layer or structure at each measuring process is narrow and that long time is necessary for the measuring process.

On the other hand, to evaluate an alignment layer for aligning the orientation of liquid crystal molecules used in Liquid Crystal Display (LCD) devices, the Japanese Non-Examined Patent Publication No. 2000-121496 published in April 2000 discloses a method of evaluating the anisotropy of an alignment layer of this type, which was invented by S. Ito. In this method, incident p-polarized light is irradiated to a sample of an alignment layer at its Brewster's angle to generate a reflected light. Then, the intensity of the s-polarized component of the reflected light is measured, evaluating the anisotropy of the layer.

With the method disclosed in the Publication No. 2000-121496, the incident p-polarized light is irradiated to a sample of an alignment layer at its Brewster's angle and thus, the intensity of the p-polarized component of the reflected light can be lowered extremely This means that the intensity of the s-polarized component of the reflected light, which is generated due to the optical anisotropy of the alignment layer, can be measured at higher accuracy.

This method is applicable when an optically anisotropic layer as the sample is formed directly on a substrate. However, this method is difficult to be applied when an optically anisotropic layer as the sample has a multilayer structure like a layered structure of a LCD device. This is because the Brewster's angle at which the p-polarized component of the reflected light is eliminated is unable to be clearly defined.

Moreover, the Japanese Non-Examined Patent Publication No. 4-95845 published in March 1992 discloses a method of evaluating the ability of an alignment layer for aligning the orientation of liquid crystal molecules, which was invented by S Ishihara. In this method, linearly polarized light is irradiated to an alignment layer to generate a reflected light. Then, the intensity of the reflected light is measured, finding the aligned state (i.e., the aligning ability) of the layer. The linearly polarized incident light has a plane of polarization perpendicular or parallel to the alignment (i.e., rubbing) direction.

When the linearly polarized incident light is irradiated perpendicularly to the surface of a sample, as disclosed in the first embodiment of the Publication No. 4-95845, the reflected light passes through the same way as the incident light. Since a light source for the incident light and an optical detector for detecting the intensity of the reflected light are unable to be located on the same optical path, the perpendicular incidence of the incident light cannot be realized.

If a beam splitter is additionally used, the light source and the optical detector need not be located on the same optical path. However, no beam splitter that conserves the polarization state of the reflected or incident light exists. As a result, in this case also, the perpendicular incidence of the incident light is impossible.

In FIG. 1 of the Publication No. 4-95845 which is referred in the first embodiment, the incident light is slightly obliquely irradiated to the surface of the sample at a specific inclination angle. In this case, each of the incident and reflected light contains the s-polarized component having a plane of polarization parallel to the sample surface and the p-polarized component having a plane of polarization perpendicular to the traveling direction of the light and the s-polarized component. Since the degree of reflection of the p-polarized component is different from that of the s-polarized component even if the sample is optically isotropic, the optical anisotropy of the sample is unable to be measured correctly.

In FIG. 2 of the Publication No. 4-95845 which is referred in the second embodiment, the incident light is obliquely irradiated to the surface of the sample at a specific large inclination angle. In this case, the incident light contains only the s-polarized component having a plane of polarization parallel to the sample surface. The p-polarized component does not have a plane of polarization perpendicular or parallel to the sample surface. This is due to the following reason.

Specifically, in order to irradiate light having a plane of polarization parallel to the rubbing direction to the sample, s-polarized incident light needs to be irradiated to the sample to be perpendicular to the rubbing direction of the sample. This is realized by irradiating s-polarized incident light to the sample to be parallel to the rubbing direction of the sample.

In particular, with an alignment layer produced by rubbing the surface or the layer with cloth, flute-shaped unevenness extending approximately parallel to the surface of the layer exists, resulting in an anisotropic surface of the layer. According to the anisotropic surface of the layer, the intensity of the reflected light varies dependent on the incidence orientation of the light.

As a result, the method disclosed in the Publication No. 4-95845 is unable to measure correctly the optical anisotropy of the sample layer. Also, if the alignment orientation of the sample layer is unknown, the a-polarized light cannot be irradiated to the sample layer in such a way as to have a plane of polarization parallel or perpendicular to the alignment direction to the sample layer.

Consequently, with the method disclosed in the Publication No. 4-95845, correct evaluation of the optical anisotropy of an alignment layer is unable to be realized.

### SUMMARY OF THE INVENTION

Accordingly, an object of the present invention is to provide a method of evaluating an optically anisotropic structure that makes it possible to realize correct and efficient evaluation of the optical anisotropy of an optically anisotropic structure, and a system used for the method.

Another object of the present invention is to provide a method of evaluating an optically anisotropic structure that ensures the efficient measurement of the in-plane distribution of anisotropy of an optically anisotropic structure, and a computer program product used for the method.

Still another object of the present invention is to provide a method of evaluating an optically anisotropic structure that makes it possible to determine the anisotropic dielectric constant, the principle dielectric constant coordinate axes, and the thickness of anisotropic part of an optically anisotropic structure, and a system used for the method.

The above objects together with others not specifically mentioned will become clear to those skilled in the art from the following description

According to a first aspect of the present invention, a method of evaluating an optically anisotropic structure is provided. This method comprises the steps of:

(a) irradiating incident light containing a first polarized component to an optically anisotropic structure, generating reflected light containing a second polarized component due to reflection by the structure;

the first polarized component being one of a s-polarized component and a p-polarized component;

the second polarized component being one of a s-polarized component and a p-polarized component and different from the first polarized component; and

(b) measuring intensity of the second polarized component of the reflected light, determining optical anisotropy of the structure.

With the method according to the first aspect of the invention, since the above-described steps (a) and (b) are carried out, correct and efficient evaluation of the optical anisotropy of an optically anisotropic structure can be realized, the measurement of the in-plane distribution of anisotropy of an optically anisotropic structure can be ensured, and the anisotropic dielectric constant, the principle dielectric constant coordinate axes, and the thickness of anisotropic part of an optically anisotropic structure can be determined.

According to a second aspect of the present invention, a system for evaluating an optically anisotropic structure is provided. This system comprises:

(a) an incident light irradiator for irradiating incident light containing a first polarized component to an optically anisotropic structure, generating reflected light containing a second polarized component due to reflection by the structure;

the first polarized component being one of a s-polarized component and a p-polarized component;

the second polarized component being one of a s-polarized component and a p-polarized component and different from the first polarized component; and

(b) a measuring subsystem for measuring intensity of the second polarized component of the reflected light beam, determining optical anisotropy of the structure

With the system according to the second aspect of the invention, the method according to the first aspect of the invention is performed. Thus, there are the same advantages as those in the method according to the first aspect.

According to a third aspect of the present invention, a method of measuring in-plane optical anisotropy distribution of an optically anisotropic structure is provided. This method comprises the steps of:

(a) inputting measuring condition;

the measuring condition including coordinate data about an initial position;

(b) moving an optically anisotropic structure based on the coordinate data about an initial position;

(c) adjusting inclination of the structure;

(d) finding an angle at which detected intensity of light is maximized;

(e) matching orientation of the structure with an orientation at which the detected intensity of light is maximized; and

(f) measuring intensity of the reflected light at specific positions defined by the measuring condition, thereby measuring in-plane optical anisotropy distribution of the structure.

With the method according to the third aspect of the invention, the in-plane optical anisotropy distribution of the optically anisotropic structure can be measured.

According to a fourth aspect of the present invention, a computer program product having a computer readable medium and a computer program recorded thereon, the computer program being operable to evaluate an optically anisotropic structure. This product comprises:

(a) code that inputs measuring condition;

the measuring condition including coordinate data about an initial position;

(b) code that moves an optically anisotropic structure based on the coordinate data about an initial position;

(c) code that adjusts inclination of the structure;

(d) code that finds an angle at which detected intensity of light is maximized;

(e) code that matches orientation of the structure with an orientation at which the detected intensity of light is maximized; and

(f) code that measures intensity of the reflected light at specific positions defined by the measuring condition, thereby measuring in-plane optical anisotropy distribution of the structure.

With the product according to the fourth aspect of the invention, the method according to the third aspect can be performed.

### BRIEF DESCRIPTION OF THE DRAWINGS

In order that the present invention may be readily carried into effect, it will now be described with reference to the accompanying drawings.

FIG. 1 is a schematic view showing the configuration of an evaluation system used for performing a method of evaluating an optically anisotropic structure according to a first example of the invention.

FIG. 2 is a schematic perspective view showing in detail the configuration of the sample stage of the evaluation system shown in FIG. 1.

FIG. 3 is a graph showing the result of measuring the incident orientation dependence of the intensity of the p-polarized component of the reflected light obtained in a comparing example of the first example of the invention, where s-polarized incident light is incident on an isotropic layer formed on a glass substrate thereby forming the reflected light while the incident orientation is changed.

FIG. 4 is a graph showing the result of measuring the incident orientation dependence of the intensity of the p-polarized component of the reflected light obtained by the method of evaluating an optically anisotropic structure according to the first example of the invention, where s-polarized incident light is incident on an anisotropic layer formed on a glass substrate thereby forming the reflected light while the incident orientation is changed.

FIG. 5 is a graph showing the result of measuring the incident orientation dependence of the intensity of the s-polarized component of the reflected light obtained in another comparing example of the first example of the invention, where p-polarized incident light is incident on an isotropic layer formed on a glass substrate thereby forming the reflected light while the incident orientation is changed

FIG. 6 is a graph showing the result of measuring the incident orientation dependence of the intensity of the s-polarized component of the reflected light obtained by a variation of the method according to the first example of the invention, where p-polarized incident light is incident on an anisotropic layer formed on a glass substrate thereby forming the reflected light while the incident orientation is changed.

FIG. 7 is a graph showing the result of measuring the positional dependence of the intensity of the s-polarized component of the reflected light obtained by a method of evaluating an optically anisotropic structure according to a second example of the invention, where p-polarized incident light is incident on a layer or sample with isotropic and anisotropic regions formed on a glass substrate thereby forming the reflected light while the incident position is changed

FIG. 8 is a schematic view showing the configuration of an evaluation system used for performing a method of evaluating an optically anisotropic structure according to a third example of the invention, where the system is operated to measure the anisotropy of a sample under computer control.

FIG. 9 is a flowchart showing the steps of the control program used in the system of FIG. 8.

FIG. 10 is a graph showing the result of measuring the in-plane distribution of the intensity of the s-polarized component of the reflected light obtained by a method of evaluating an optically anisotropic structure according to the third example of the invention, where p-polarized incident light is incident on a layer or sample with isotropic and anisotropic regions formed on a glass substrate thereby forming the reflected light while the incident position is changed.

FIG. 11 is a graph showing the result of measuring the incident orientation dependence of the intensity of the p-polarized component of the reflected light obtained by a method of evaluating an optically anisotropic structure according to a fourth example of the invention, where s-polarized incident light is incident on an anisotropic layer formed an a Cr-evaporated glass substrate thereby forming the reflected light while the incident orientation is changed, in which the curve Indicates the measurement result and the square dots indicate the calculation result.

FIG. 12 is a flowchart showing the steps of the computer program used in the method according to the fourth example of FIG. 11 to determine the thickness of the anisotropic structure.

FIG. 13 is a schematic view showing the configuration of an evaluation system used for performing a method of evaluating an optically anisotropic structure according to a fifth example of the invention, where the system comprises a light source for emitting light with continuous wavelength and a spectroscope.

FIG. 14 is a graph showing the result of measuring the incident orientation dependence of the intensity of the p-polarized component of the reflected light obtained by the method according to the fifth example of FIG. 13, where s-polarized incident light (450 nm in wavelength) is incident on an anisotropic layer formed on a Cr-evaporated glass substrate thereby forming the reflected light while the incident orientation is changed.

FIG. 15 is a graph showing the result of measuring the incident orientation dependence of the intensity of the p-polarized component of the reflected light obtained by the method according to the fifth example of FIG. 13, where s-polarized incident light (650 nm in wavelength) is incident on an anisotropic layer formed on a Cr-evaporated glass substrate thereby forming the reflected light while the incident orientation is changed.

FIG. 16 is a schematic view showing the configuration of an evaluation system used for performing a method of evaluating an optically anisotropic structure according to a sixth example of the invention, where the system comprises a light source for emitting light with continuous wavelength and a spectroscope.

FIG. 17 is a schematic view showing the configuration of an evaluation system used for performing a method of evaluating an optically anisotropic structure according to a seventh example of the invention, where the system comprises a two-dimensional, position-sensitive optical detector and is applicable to measuring the in-plane distribution of the anisotropy of the structure

FIG. 18 is a schematic view showing the configuration of another evaluation system used for performing a method of evaluating an optically anisotropic structure according to an eighth example of the invention, where two sets of an analyzer and a photodetector are arranged in such a way that incident orientation of the reflected light to the detectors is different from each other.

FIG. 19 is a schematic view showing the configuration of a still another evaluation system used for performing a method of evaluating an optically anisotropic structure according to a ninth example of the invention, where two sets of an analyzer and a photodetector are aligned in a horizontal direction.

### DETAILED DESCRIPTION OF THE INVENTION

As described above, the method according to the first aspect of the present invention comprises the following steps (a) and (b).

In the step (a), incident light containing a first polarized component is irradiated to an optically anisotropic structure, generating reflected light containing a second polarized component due to reflection by the structure.

The first polarized component is one of a s-polarized component and a p-polarized component. The second polarized component is one of a s-polarized component and a p-polarized component and different from the first polarized component.

In the step (b), intensity of the second polarized component of the reflected light is measured, determining optical anisotropy of the structure.

With the method according to the first aspect of the invention, the following fact is utilized.

Specifically, when “s-polarized” incident light is irradiated to an optically “isotropic” medium, reflected light generated by reflection of the incident light is “s-polarized one” (which is the same as the incident one). When “p-polarized” incident light is irradiated to an optically “isotropic” medium, reflected light generated by reflection of the incident light is “p-polarized one” (which is the same as the incident one as well).

Unlike this, when “s-polarized” incident light is irradiated to an optically “anisotropic” medium, reflected light generated by reflection of the incident light contains not only a “s-polarized” component but also a “p-polarized” component. Similarly, when “p-polarized” incident light is irradiated to an optically “anisotropic” medium, a reflected light generated by reflection of the incident light contains not only a “p-polarized” component but also a “s-polarized” component.

In the method according to the first aspect of the invention, the incident light containing the first polarized component is irradiated to the optically anisotropic structure, generating the reflected light containing the second polarized component due to reflection by the structure in the step (a) The first polarized component is one of a s-polarized component and a p-polarized component while the second polarized component is one of a s-polarized component and a p-polarized component and different from the first polarized component. This means that when the first polarized component is a s-polarized component (or p-polarized component), the second polarized component is a p-polarized component (or s-polarized component).

As known well, the p-polarized component is orthogonal to the s-polarized component. Therefore, it may be said that the first polarized component is a first one of orthogonally polarized components while the second polarized component is a second one thereof.

Thereafter, in the step (b), the intensity of the second polarized component of the reflected light is measured, determining the optical anisotropy of the structure.

As a result, the measurement operation in the step (b) is not affected by the surface state of the optically anisotropic structure. This is unlike a method where linearly polarized incident light is simply irradiated to an optically anisotropic structure and then, the intensity of the reflected light of the incident light is measured.

In addition, if s- or p-polarized incident light is irradiated to the structure in such a way that the incidence plane of the incident light is parallel to the alignment orientation of the structure, the polarized component of the reflected light perpendicular to that of the incident light is equal to zero independent of the existence or absence of the optical anisotropy of the structure. Thus, this is unsuitable to measurement of the optical anisotropy of the structure.

Also, in the case that the anisotropic part or region of the structure has principal dielectric constant coordinate axes parallel to the surface of the structure, if s- or p-polarized incident light is irradiated to the structure in such a way that the incidence plane of the incident light is perpendicular to the alignment orientation of the structure, the polarized component (i.e., the s- or p-polarized component) of the reflected light is equal to zero as well Thus, this is unsuitable to measurement of the optical anisotropy of the structure.

Accordingly, s- or p-polarized incident light is irradiated to the structure in such a way that the incidence plane of the incident light is parallel to the alignment orientation of the structure and at the same time, the structure is turned to change the incident orientation of the incident light, finding an orientation at which the intensity of the reflected light is maximized. Thus, the orientation of the structure can be determined.

Since the intensity of the reflected light has a dependency on the incident angle of the incident light, the incident angle is chosen or determined so as to maximize the intensity of the reflected light. Therefore, in this case, the intensity of the s-polarized light (which is usually extremely weak), or, the polarized component of the reflected light perpendicular to the polarized component of the p-polarized incident light (which is irradiated to the structure in such a way that the incidence plane of the incident light is parallel to the alignment orientation of the structure) is increased. This means that the measurement operation can be realized with a high signal-to-noise ratio (S/N).

The incident-orientation dependence of the detected intensity of the reflected light reflects the magnitude of the optical anisotropy, the inclination angle of the principal dielectric constant coordinate axes with respect to the structure surface, and the alignment orientation of the structure. Thus, the magnitude of the optical anisotropy, the inclination angle of the principal dielectric constant coordinate axes, and the alignment orientation of the structure can be determined on the basis of the incidence-orientation dependency of the detected intensity. This is realized by providing a rotatable sample stage for the structure.

The detected intensity of the reflected light varies dependent on the incident angle of the incident light according to the state of the optical anisotropy. Therefore, the incidence-angle dependence can be measured along with the incidence-orientation dependence, which improves the measurement accuracy on the state of the optical anisotropy or the structure.

When the procedures or the measurement, calculation, and the determination of the optical anisotropy of the structure are automated with computer, the structure is efficiently evaluated.

In a preferred embodiment of the method according to the first aspect, the structure is translated with respect to the structure in the step (b), thereby measuring in-plane distribution of optical anisotropy of the structure. In this embodiment, there is an additional advantage that a wide area of the structure can be measured in a short time.

In another preferred embodiment of the method according to the first aspect, the structure is turned around an axis in the step (b), thereby determining orientation or principal dielectric constant coordinate axes of the structure. In this embodiment, there is an additional advantage that measurement is possible even if the alignment orientation of the structure is unknown.

In still another preferred embodiment of the method according to the first aspect, the intensity of the second polarized component of the reflected light is measured with detectors aligned in a direction while the structure is moved in parallel to the detectors in the step (b), thereby determining in-plane distribution of optical anisotropy of the structure. In this embodiment, there is an additional advantage that a wide area of the structure can be measured in a short time.

In a further preferred embodiment of the method according to the first aspect, the intensity of the second polarized component of the reflected light is measured with detectors arranged in such a way that incident orientation of the reflected light to the detectors is different from each other in the step (b), thereby determining in-plane distribution and orientation of optical anisotropy of the structure. In this embodiment, there is an additional advantage that the in-plane distribution and orientation of optical anisotropy of the structure can be measured in a short time.

In a further preferred embodiment of the method according to the first aspect, the intensity of the second polarized component of the reflected light is measured with detectors arranged in parallel while the structure is translated parallel to the detectors in the step (b), thereby determining in-plane distribution of optical anisotropy of the structure. In this embodiment, there is an additional advantage that the in-plane distribution of optical anisotropy of the structure can be measured in a short time.

In a still further preferred embodiment of the method according to the first aspect, the incident light is irradiated to the structure at an incident angle in such a way that the second polarized component of the reflected light is maximized in the step (a).

In a more further preferred embodiment of the method according lo the first aspect, the incident light is irradiated to the structure at an incident angle and an incident orientation in such a way that the second polarized component of the reflected light is maximized in the step (a).

In a still more preferred embodiment of the method according to the first aspect, the incident light having a constant cross-section is used in the step (a) . The intensity of the second polarized component of the reflected light is measured with a two-dimensional optical detector (e.g., a two-dimensional CCD) that detects the position in a plane in the step (b). In this embodiment, there is an additional advantage that the in-plane distribution of the optical anisotropy of the structure can be measured In a short time.

Preferably, a polarizer for generating the incident light and an analyzer for selecting the second component of the reflected light are additionally used. In this case, each of the polarizer and analyzer has a high extinction ratio to raise the measurement accuracy. Since the characteristics of the polarizer and analyzer have wavelength dispersion, it is not preferred that light with continuous spectrum is used for the incident light. The incident light needs to have a spectrum with a narrow wavelength width and therefore, monochromatic light is preferably used. If light with continuous spectrum is used for the incident light, the reflected light needs to be analyzed spectroscopically.

The system according to the second aspect of the present invention comprises:

(a) an incident light irradiator for irradiating incident light containing a first polarized component to an optically anisotropic structure, generating reflected light containing a second polarized component due to reflection by the structure;

the first polarized component being one of a s-polarized component and a p-polarized component;

the second polarized component being one of a s-polarized component and a p-polarized component and different from the first polarized component; and

(b) a measuring subsystem for measuring intensity of the second polarized component of the reflected light beam, determining optical anisotropy of the structure.

With the system according to the second aspect of the invention, it is obvious that the method according to the first aspect of the invention is performed. Thus, there are the same advantages as those in the method according to the first aspect.

The method according to the third aspect of the present invention is a method of measuring in-plane optical anisotropy distribution of an optically anisotropic structure. As described above, this method comprises the steps of.

(a) inputting measuring condition;

the measuring condition including coordinate data about an initial position;

(b) moving an optically anisotropic structure based on the coordinate data about an initial position;

(c) adjusting inclination of the structure;

(d) finding an angle at which detected intensity of light is maximized;

(e) matching orientation of the structure with an orientation at which the detected intensity of light is maximized; and

(f) measuring intensity of the reflected light at specific positions defined by the measuring condition, thereby measuring in-plane optical anisotropy distribution of the structure.

With the method according to the third aspect of the invention, the in-plane optical anisotropy distribution of the optically anisotropic structure can be measured.

The computer program product according to the fourth aspect of the present invention is a computer program product having a computer readable medium and a computer program recorded thereon. The computer program is operable to evaluate an optically anisotropic structure.

As described above, this product comprises:

(a) code that inputs measuring condition;

the measuring condition including coordinate data about an initial position;

(b) code that moves an optically anisotropic structure based on the coordinate data about an initial position;

(c) code that adjusts inclination of the structure;

(d) code that finds an angle at which detected intensity of light is maximized;

(e) code that matches orientation of the structure with an orientation at which the detected intensity of light is maximized; and

(f) code that measures intensity of the reflected light at specific positions defined by the measuring condition, thereby measuring in-plane optical anisotropy distribution of the structure.

### EXAMPLES

Preferred examples of the present invention will be described in detail below while referring to the drawings attached.

### First Example

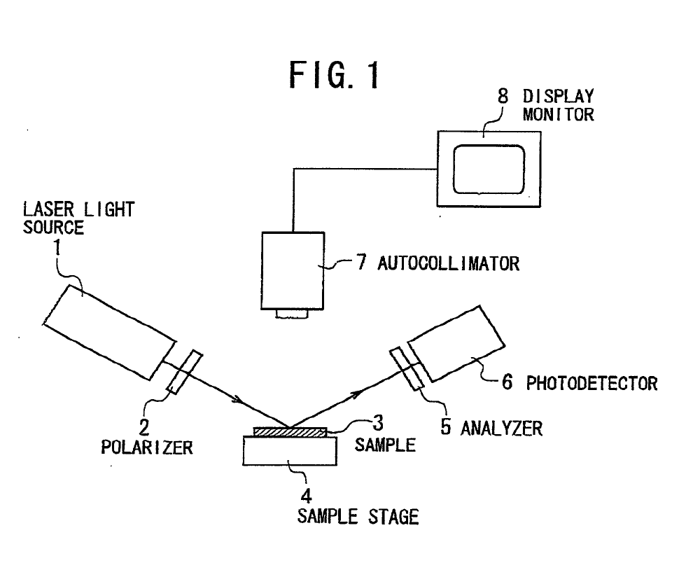

An evaluation system used for performing a method of evaluating an optically anisotropic structure according to a first example of the invention is schematically shown in FIG. 1.

As seen from FIG. 1, the evaluation system comprises a monochrome light source (i.e., He—Ne laser) 1, a polarizer 2, a movable sample stage 4 on which a sample 3 (i.e., optically anisotropic structure) is placed and held, an analyzer 5, a photodetector (i.e., photodiode) 6, an autocollimator 7, and a display monitor 8.

The light source 1 emits beam-shaped monochrome light as incident light toward the sample 3 placed on the stage 4. The polarizer 2 allows selectively the p-polarized component of the incident light to pass through the same. The p-polarized component of the incident light is reflected by the sample 3, generating reflected light. The reflected light contains not only a p-polarized component but also a s-polarized component. The analyzer 5 allows selectively the s-polarized component of the reflected light to pass through the same. The photodetector 6 detects the s-polarized component of the reflected light and measures its intensity.

The autocollimator 7 is used to confirm the inclination of the surface of the sample 3 on the stage 4. The display monitor 8 is used to raise the efficiency of adjusting the surface inclination of the sample 3. Specifically, the reflection position on the surface of the sample 3, which is obtained by the autocollimator 7, is monitored with a Charge-Coupled Device (CCD) camera (not shown). The image showing the reflection position is displayed on the screen of the monitor 8.

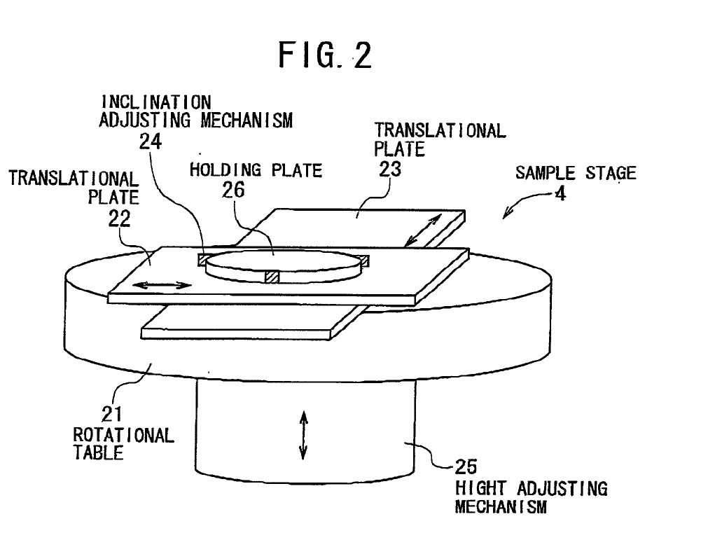

The sample stage 4 is movable vertically and horizontally to expand the measurable range for the sample 3. The detailed structure is shown in FIG. 2. As seen from FIG. 2, the stage 4 comprises a rotational table 21, two translational plates 22 and 23, an inclination adjusting mechanism 24, a height adjusting mechanism 25, and a sample holding plate 26.

The rotational table 21 is held horizontally by the height adjusting mechanism 25. The translational plates 22 and 23 are supported by the table 21 in such a way as to be movable in horizontal directions perpendicular to each other. The inclination adjusting mechanism 24 serves to adjust the inclination of the plate 26 with respect to a horizontal plane. The height adjusting mechanism 25 serves to adjust the height of the table 21 (i.e., the sample 3). The sample support plate 26 serves to hold directly the sample 3 placed thereon.

Next, the method of evaluating an optically anisotropic structure according to the first example, which is conducted with the evaluation system of FIG. 1, is explained below.

First, a layer of a polyimide (PI-C, Nissan Chemical Inc.) was formed on a glass substrate (7059, Corning Inc.) by the spin coating method. The polyimide layer thus formed was heated at 90° C. for 30 minutes and then, heated again at 250° C. for 60 minutes for curing.

At this stage, the thickness of the polyimide layer thus cured was measured with an ellipsometer (MARY-102, Five-Labo. Inc.) while the incident angle was set as 70°. As a result, it was found that the thickness of the polyimide layer was 72 nm.

Thereafter, a rubbing process using a rubbing roller (50 mm in diameter) covered with a rubbing cloth was repeated twice to the polyimide layer under the condition that the pushing depth of the roller was 0.05 mm, the rotating rate of the roller was 800 rpm, and the moving rate of the substrate was 30 mm/sec. Thus, the sample 3 with the rubbed polyimide layer (i.e., an optically anisotropic layer) on the glass substrate was formed.

The thickness and the refractive index of the sample 3 thus formed were measured at 10 points on the surface of the sample 3 with an ellipsometer using a He—Ne laser as a light source. As a result, it was found that the thickness of the polyimide layer was 59±4 nm and the refractive index was 1.62±0.1.

Additionally, a comparative sample was formed in the same way as above except that the above-described rubbing process was omitted.

The light emitted from the light source (i.e., He—Ne laser with an output of 1 mW) 1 was irradiated to the sample 3 or the comparative sample placed on the sample stage 4 at the incident angle of 50°. Due to the polarizer 2, only the p-polarized component of the laser light was irradiated to the sample 3. The p-polarized component of the laser light was reflected on the surface of the sample 3 (i.e., the polyimide layer on the glass substrate), thereby generating reflected light containing a p-polarized component and a s-polarized component. Since the analyzer 5 allowed only a s-polarized component of light to pass through the same, the photodetector (i.e., photodiode) 6 detected only the s-polarized component of the reflected light. Thus, the intensity of the s-polarized component of the reflected light was measured by the photodetector 6 while the incident orientation of the laser light was changed using the rotatable stage 4. As a result, the incident angle dependence of the intensity of the s-polarized component of the reflected light was obtained.

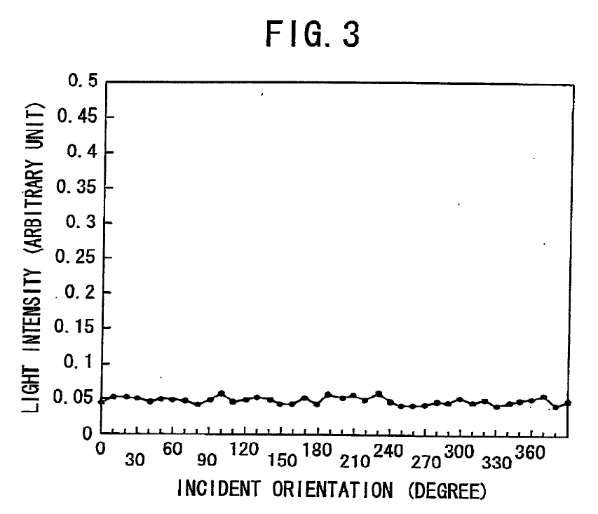

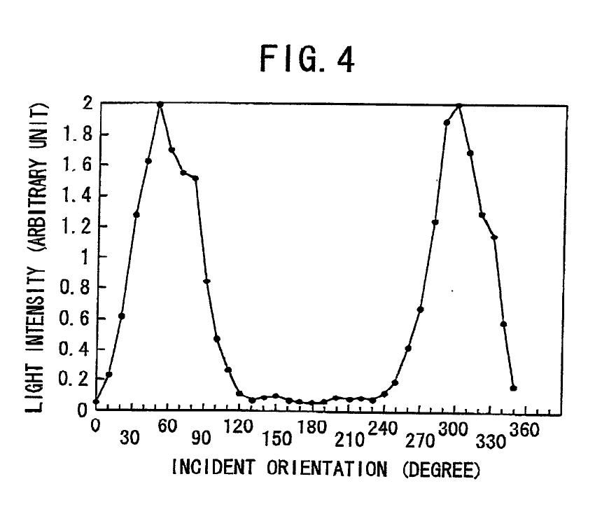

The measurement result of the comparative sample (not rubbed) and that of the sample 3 (rubbed) are shown in FIGS. 3 and 4, respectively

As seen from FIG. 4, with the sample 3 having the aligned polyimide layer (i.e., optically anisotropic layer), the intensity of the reflected light shows conspicuously the periodic change according to the incident orientation from 0° to 360°. This is a reflection of the optical “anisotropy” of the polyimide layer.

On the other hand, with the comparative sample having the unaligned polyimide layer (i.e., optically isotropic layer), as shown in FIG. 3, the intensity of the reflected light shows substantially no change even if the incident orientation is changed from 0° to 360°. This is a reflection of the optical “isotropy” of the polyimide layer.

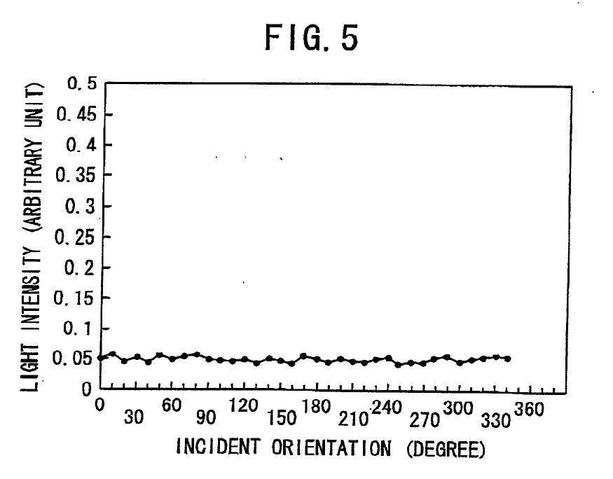

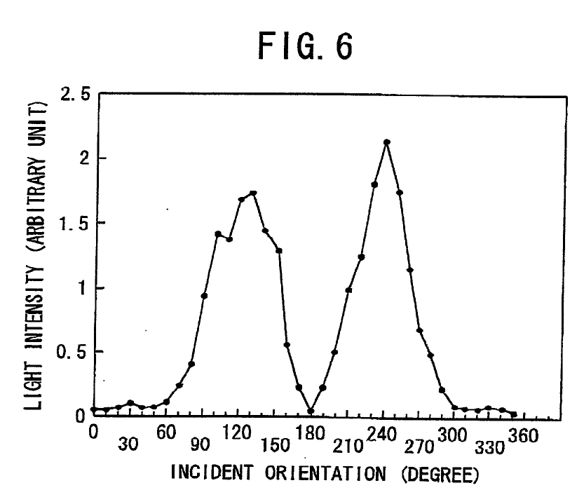

FIGS. 5 and 6 show the measurement result of the comparative sample (not rubbed) and that of the sample 3 (rubbed), where only the s-polarized (not p-polarized) component of the laser light was irradiated to the samples due to the polarizer 2. The other measuring condition was the same as that for FIGS. 3 and 4.

As seen from FIG. 6, with the sample 3 with the aligned polyimide layer (i.e., optically anisotropic layer) the intensity of the reflected light shows conspicuously the periodic change according to the incident orientation from 0° to 360°. This is a reflection of the optical “anisotropy” of the polyimide layer. However, the periodicity of the periodic change is less clear than that of FIG. 3, which is due to the use of the s-polarized component of the laser light.

Also, with the comparative sample having the unaligned polyimide layer (i.e. optically isotropic layer), as shown in FIG. 5, the intensity of the reflected light shows substantially no change even if the incident orientation is changed from 0° to 360°. This is similar to the result of FIG. 4.

In addition, the Japanese Non-Examined Patent Publication No. 4-95845 referred earlier discloses a configuration that a polarizer is located near a laser light source and an analyzer is located near a photodetector in its second and third examples and FIG. 2. This is similar to the evaluation system according to the first example of FIG. 1. However, as clearly described in this Publication, the polarizer and the analyzer in this Publication are used to eliminate the effect of the reflected light generated by reflection on the back surface of the substrate, thereby improving the S/N. They are not used to separate a polarized component of the light.

Moreover, as clearly described in the Publication No. 4-95845, the analyzer is not always necessary, in other words, it is not technically essential.

As a result, the configuration of the system disclosed in the Publication is clearly different from the system of the first example.

### Second Example

A method of evaluating an optically anisotropic structure according to a second example was conducted using the evaluation system as shown in FIGS. 1 and 2 in the following way.

First, a layer of a polyimide (PI-B, Nissan Chemical Inc.) was formed on a glass substrate (7059, Corning Inc.) by the spin coating method. The polyimide layer thus formed was heated at 90° C. for 30 minutes and then, heated again at 250° C. for 60 minutes for curing.

At this stage, the thickness of the polyimide layer thus cured was measured with an ellipsometer (MARY-102, Five-Labo. Inc.) while the incident angle was set as 70°. As a result, it was found that the thickness of the polyimide layer was 72 nm.

Thereafter, a rubbing process using a rubbing roller (50 mm in diameter) covered with a rubbing cloth was repeated twice to the polyimide layer under the condition that the pushing depth of the roller was 0.05 mm, the rotation rate of the roller was 800 rpm, and the moving rate of the substrate was 30 mm/sec.

Furthermore, part of the polyimide layer was immersed into acetone at room temperature for 60 minutes, immersed into pure water at room temperature for 10 seconds, and dried in the atmosphere. Thus, the sample 3 with the aligned polyimide layer (i.e., an optically anisotropic layer) on the glass substrate was formed The sample 3 included the acetone-immersed part and the non-immersed remainder.

The light emitted from the light source (i.e., He—Ne laser with an output of 1 mW) 1 was irradiated to the sample 3 placed on the sample stage 4 at the incident angle of 50°. Due to the polarizer 2, only the p-polarized component of the laser light is irradiated to the sample 3. The p-polarized component of the laser light was reflected on the surface of the sample 3 (i.e., the polyimide layer on the glass substrate), thereby generating reflected light containing a p-polarized component and a s-polarized component. Since the analyzer 5 allowed only a s-polarized component of light to pass through the same, the photodetector (i.e., photodiode) 6 detected only the s-polarized component of the reflected light. Thus, the intensity of the s-polarized component of the reflected light was measured by the photodetector 6.

At this measuring stage, the position of the sample 3 on the stage 4 was adjusted using the translational plates 23 and 24 in such a way that the incident laser light was irradiated to the part of the sample 3 that had not been contacted with acetone. The orientation of the incident laser light was fixed at an orientation where the intensity of the light detected was maximized. The incident orientation maximizing the intensity of the light detected was determined in the same way as shown in the method according to the first example.

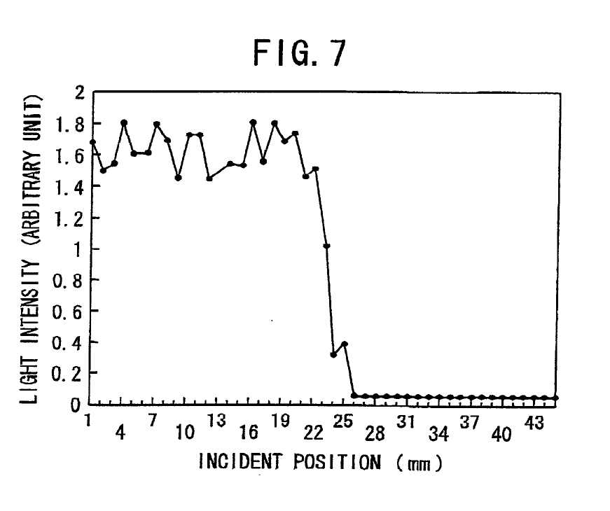

While the position of the sample 3 and the incident orientation of the laser light thus adjusted were kept unchanged, the plate 22 of the sample stage 4 was successively moved in a horizontal direction at each interval of 1 mm. Thus, the positional dependence of the intensity of the reflected light was measured, providing the resulting shown in FIG. 7

As seen from FIG. 7, it was found that the intensity showed a large difference as the incident position varied. In particular, it was found that the s-polarized component of the reflected light was scarcely observed when the laser light was irradiated to the acetone-immersed part of the sample 3, in other words, the optical anisotropy of the immersed part of the sample 3 disappeared.

As seen from the above explanation, the method according to the second example made it possible to measure the positional dependence or the optical anisotropy or the sample 3.

### Third Example

With a method of evaluating an optically anisotropic structure according to a third example, the in-plane distribution of the optical anisotropy or a sample was measured. The sample stage 4 shown in FIGS. 1 and 2 and the sample 3 formed in the second example were used.

The light emitted from the light source (i.e., He—Ne laser with an output of 1 mW) 1 was irradiated to the sample 3 placed on the sample stage 4 at the incident angle of 50°. Unlike the second example, only the s-polarized component of the laser light was irradiated to the sample 3 due to the operation of the polarizer 2, thereby generating reflected light containing a p-polarized component and a s-polarized component. Because of the operation or the analyzer 5, only a p-polarized component of the reflected light enters the photodetector (i.e., photodiode) 6 and detected, which is unlike the second example also. Thus, the intensity of the p-polarized component of the reflected light was measured by the photodetector 6.

At this measuring stage, the position of the sample 3 on the stage 4 was adjusted using the translational plates 23 and 24 in such a way that the incident laser light was irradiated to the non-immersed part of the sample 3. The orientation of the incident laser light was fixed at an orientation where the intensity of the light detected was maximized. The incident orientation that maximized the intensity of the light detected was determined in the same way as shown in the method according to the second example.

While the position of the sample 3 and the incident orientation of the laser light thus adjusted were kept unchanged, the plates 22 and 23 were successively moved in the respective horizontal directions at each interval of 1 mm. Thus, the positional dependence of the intensity of the reflected light was measured at the points in the form of matrix array.

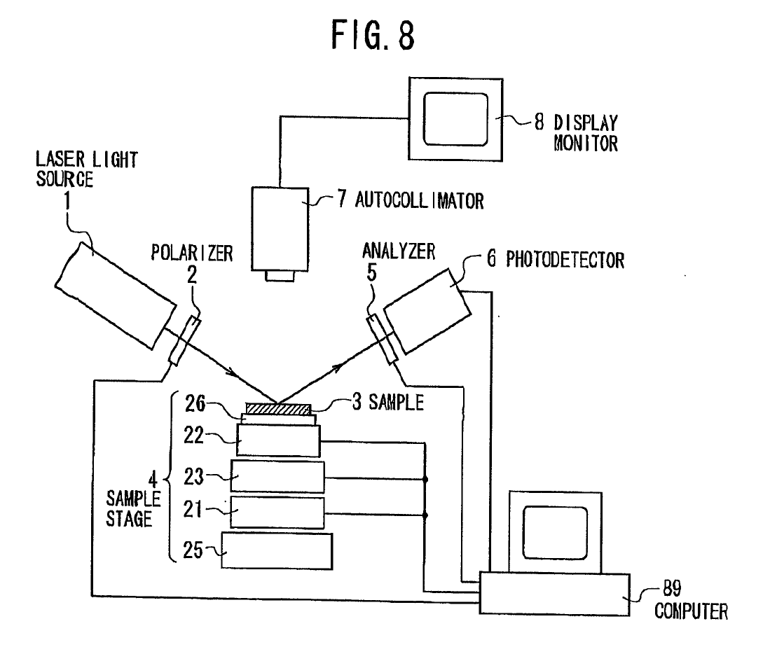

To raise the efficiency of the measurement, all the measuring procedures, such as the moving operation of the stage 4, the measuring operation, and the data recording operation were automatically controlled with a computer. The evaluation system used in the third example had the configuration shown in FIG. 8.

The system in FIG. 8 has the same configuration as that of the system as shown in FIGS. 1 and 2 except that a computer 89 is additionally provided. Therefore, the explanation about the same configuration is omitted here by attaching the same reference numerals as those in FIGS. 1 and 2 for the sake of simplification.

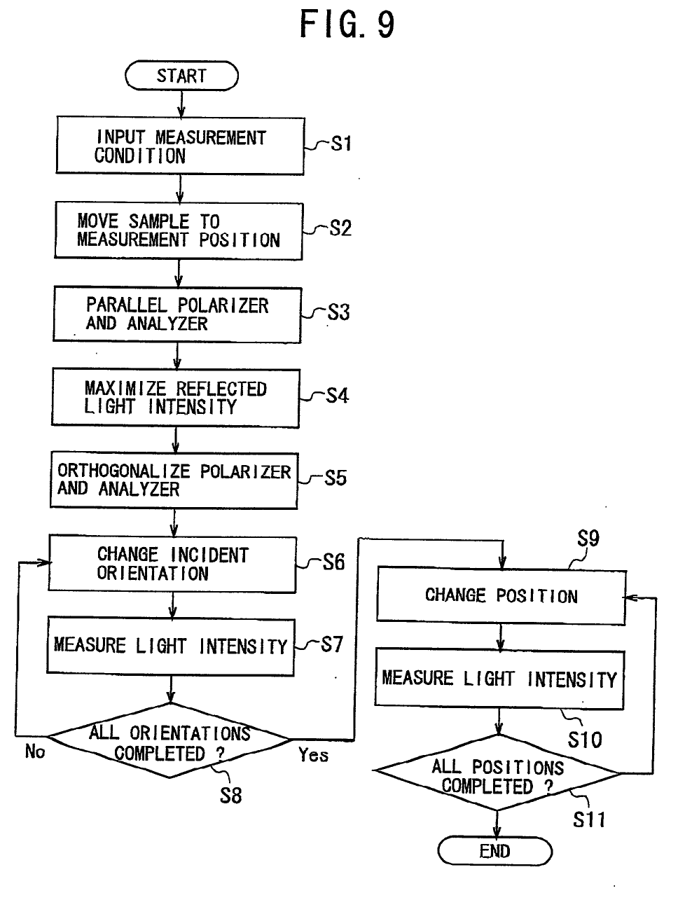

The automatic measuring operation of the system shown in FIG. 8 was carried out according to the flowchart shown in FIG. 9.

In the step S1, a set of data for the measuring condition (e.g., initial position coordinates, orientation intervals, measuring intervals, and measuring directions) is inputted.

In the step S2, the sample 3 is moved to the measurement position defined by the condition thus inputted. The inclination of the sample 3 is adjusted on the basis of the measurement result using the autocollimator 7.

In the step S3, to optimize the height of the sample 3, the polarizer 2 and the analyzer 5 are paralleled with each other.

In the step S4, the rotational table 21 of the sample stage 4 is turned or rotated in a horizontal plane, maximizing the intensity of the reflected light detected. In other words, the incident angle that maximizes the intensity of the reflected light is found.

In the step S5, the polarizer 2 and the analyzer 5 are orthogonalized with each other.

In the steps S6 to S8, the incident orientation or the incident laser light is changed at specific angle intervals (e.g., 10°) from 0° to 360° according to the measurement condition inputted and the intensity of the reflected light is measured at each incident orientation (i.e. each angle). Thereafter, the incident laser light is fixed at the specific incident orientation that maximizes the intensity measured.

In the steps S9 to S11, the sample 3 is moved to the respective measurement positions defined in advance by automatically controlling the movement of the translational plates 22 and 23 with the computer 89. Then, the intensity of the reflected light is measured at each of these positions. The intensity values thus obtained and the relating positional data are automatically recorded in the computer 89.

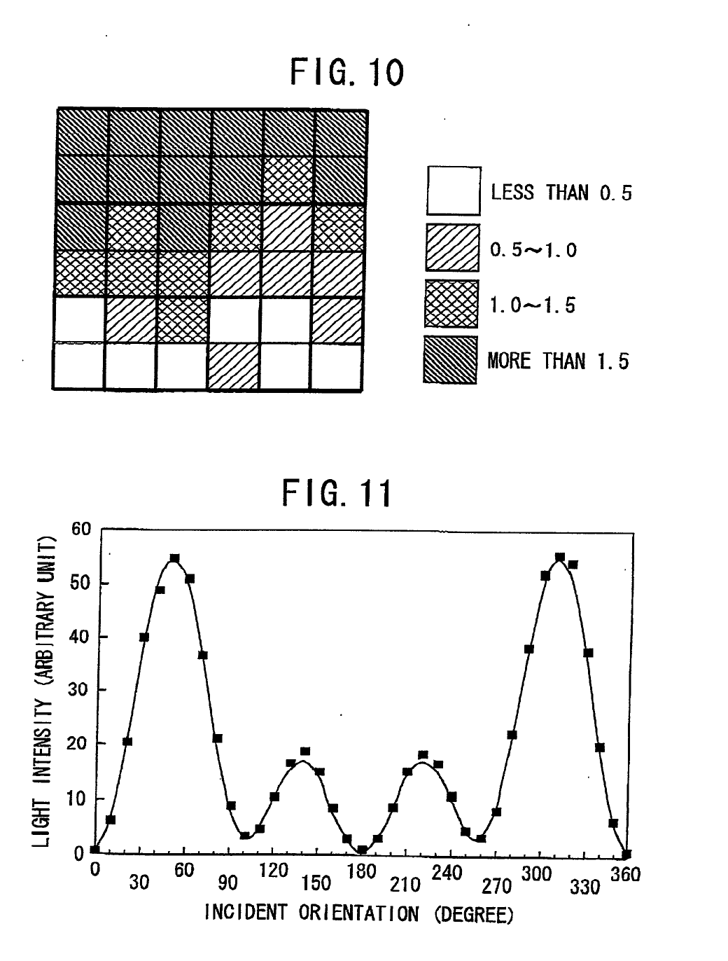

FIG. 10 shows the result of the actual measurement according to the method of third example, in which the measurement position was changed among six values with equal intervals of 1 mm and the incident orientation was changed among six ones. Thus, the intensity data were observed at 36 points in total.

In addition, if a plurality of the combinations of the light source 1, the polarizer 2, the analyzer 5, and the photodetector 6 are assembled, the optical anisotropy at several points can be measured simultaneously.

As explained above, the in-plane distribution of the optical anisotropy of the sample 3 was measured.

### Fourth Example

A method of evaluating an optically anisotropic structure according to a fourth example was conducted using the evaluation system as shown in FIGS. 1 and 2 in the following way. In this method, the incident orientation dependence of the intensity of the reflected light was measured.

First, a chromium (Cr) film was deposited on the surface of a glass by the vacuum evaporation method, forming a Cr film. Then, a layer of a polyimide (PI-A, Nissan Chemical Inc.) was formed on the Cr film of the glass substrate by the spin coating method. The polyimide layer thus formed was heated at 90° C. for 30 minutes and then, heated again at 250° C. for 60 minutes for curing

At this stage, the thickness of the polyimide layer was measured with an ellipsometer (MARY-102, Five-Labo. Inc.) while the incident angle was set as 70°. As a result, it was found that the thickness of the polyimide layer was 20 nm.

Thereafter, a rubbing process using a rubbing roller (50 mm in diameter) covered with a rubbing cloth was repeated twice to the polyimide layer under the condition that the pushing depth of the roller was 0.05 mm, the rotating rate of the roller was 800 rpm, and the moving rate of the substrate was 30 mm/sec.

The optical anisotropy of the polyimide layer was measured under the condition that the incident angle was 50°, the orientation angle was 10°, the s-polarized component of the laser light was selectively passed by the polarizer 2, and the p-polarized component of the reflected light was selectively passed by the analyzer 5.

To determine the optical anisotropy of the polyimide layer on the basis of the intensity of the light measured, it was supposed that the polyimide layer was a uniaxial, optically anisotropic medium with no absorbency. Moreover, the value of the p-polarized component of the reflected light was calculated according to the known “4×4 matrix” method while the two anisotropic dielectric constants and the thickness of the polyimide layer, the inclination angle of the principal dielectric constant coordinate axes with respect to the surface of the polyimide layer, and the orientation of the principal dielectric constant coordinate axes were defined as parameters.

The “4×4 matrix” method is disclosed in, for example, the book entitled “Ellipsometry and Polarized Light” written by Azzam and Bashara, North-Holland 1987, pp 341-363.

Subsequently, the normalized constant among the parameters defining the state of the polyimide layer and the calculated and measured values were optimized using the “least-squares method” until the calculation result accorded with the measurement result. Thus, it was determined that the two anisotropic dielectric constants were 2.64 and 2.58, the thickness of the polyimide layer was 20 nm, the inclination angle of the principal dielectric constant coordinate axes with respect to the surface of the polyimide layer was 35°, the orientation of the principal dielectric constant coordinate axes was 2°, and the normalized constant was 9,000,000. Thus, the measurement result as shown in FIG. 11 was obtained.

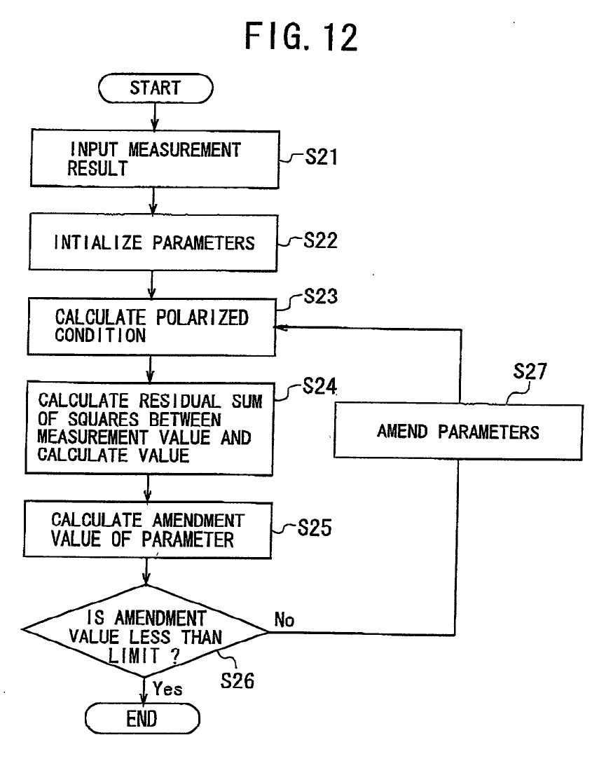

The above-described optimization procedure was conducted automatically with a computer according to the flowchart shown in FIG. 12.

As shown in FIG. 12, first, the measurement result is inputted into the computer (step S21). Next, the parameters are initialized (step S22) and the polarized condition is calculated (step S23). Thereafter, the residual sum of the squares of the measured value and the calculated value is calculated (step S24) and then, the amendment value of each parameter is calculated (step S25). The steps S23 to S25 are repeated until the amendment value is equal to the specific limit (step S26).

As explained above, with the method according to the fourth example, the incident orientation dependence of the intensity of the reflected light was measured.

### Fifth Example

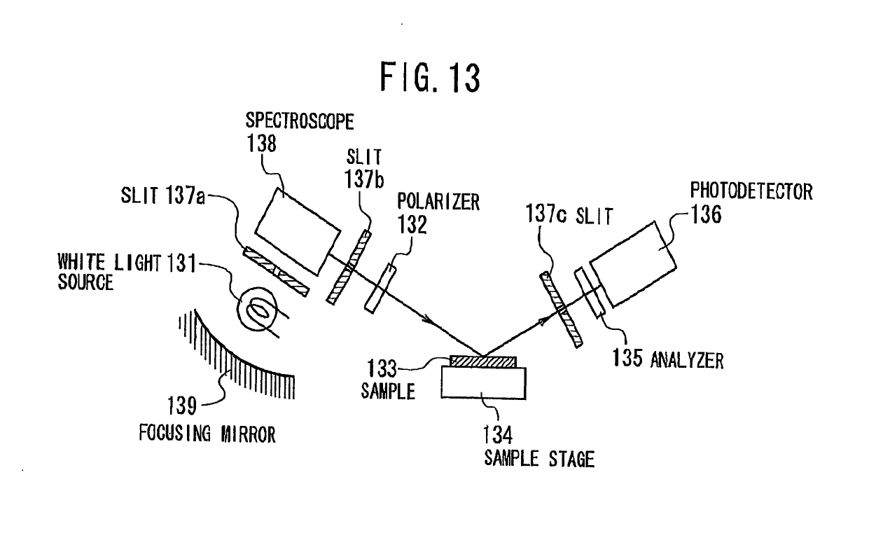

An evaluation system used for performing a method of evaluating an optically anisotropic structure according to a fifth example of the invention is schematically shown in FIG. 13.

As seen from FIG. 13, the evaluation system comprises a white light source (i.e., halogen lamp) 131, a polarizer 132, a movable sample stage 134 on which a sample 133 (i.e., optically anisotropic structure) is placed, an analyzer 135, a photodetector (i.e., photodiode) 136, three slits 137a, 137b, and 137c, a spectroscope 138 (i.e., diffraction grating), and a focusing mirror 139.

The light source 131 emits white light as incident light to the spectroscope 138 by way of the slit 137a. The focusing mirror 139 reflects the white light and focuses it toward the spectroscope 138. Thus, the white light is converted to monochromic light by the spectroscope 138. The monochromic light thus generated is irradiated to the sample 133 placed on the stage 134 by way of the slit 137b and the polarizer 132, thereby generating reflected light. The reflected light enters the photodetector 136 by way of the slit 137c and the analyzer 135.

The polarizer 132 allows selectively a p-polarized or s-polarized component of the incident light to pass through the same. The reflected light contains not only a p-polarized component but also a s-polarized component. The analyzer 135 allows selectively the s- or p-polarized component of the reflected light to pass through the same. In other words, the analyzer 135 allows selectively a polarized component of the reflected light perpendicular or orthogonal to the selected component of the incident light. The photodetector 136 detects the polarized component of the reflected light that has passed through the analyzer 135 and measures its intensity.

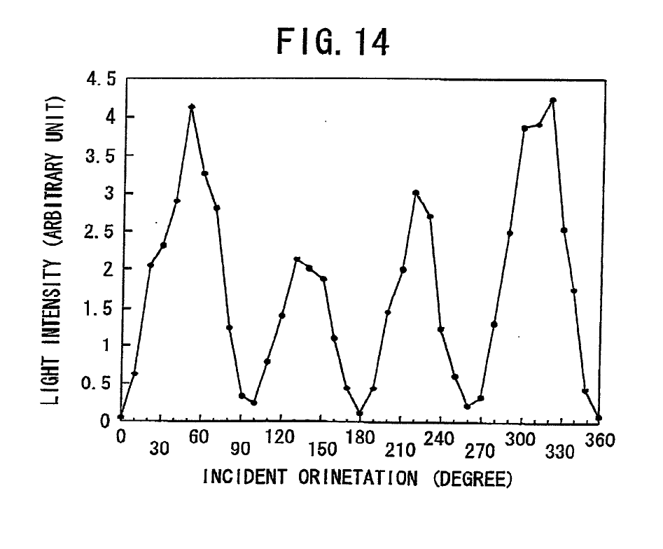

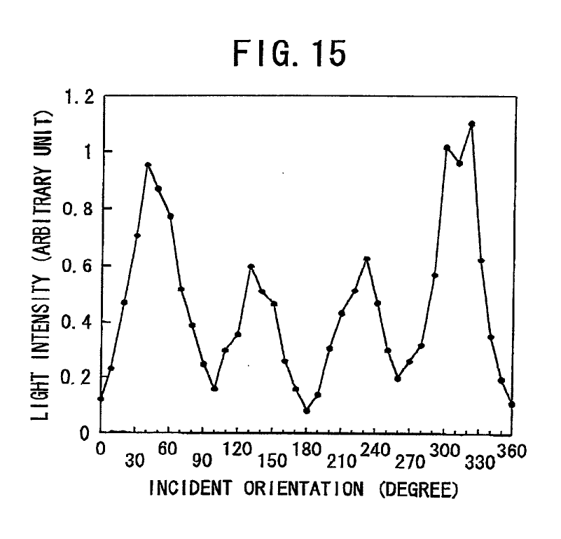

In the method according to the fifth example, the same sample 3 as used in the fourth example was used. The light (wavelength: 450 nm and 650 nm) emitted from the light source 131 was irradiated to the sample 133 placed on the sample stage 134 at the incident angle of 50°. The measurement result obtained by this method is shown in FIGS. 14 and 15.

As seen from FIGS. 14 and 15, the intensity of the reflected light for 450 nm is greater than that for 650 nm. This is because the wave number of the light passing through the optically anisotropic part of the sample 133 increases as the wavelength decreases. As a result, the effect by the optical anisotropy appears more conspicuously.

With the method of the fifth example, the measurement result of the two wavelengths were utilized and therefore, there is an additional advantage that the optical parameters such as the dielectric constant and thickness of the optically isotropic layer as shown in the fourth example can be determined at higher accuracy.

### Sixth Example

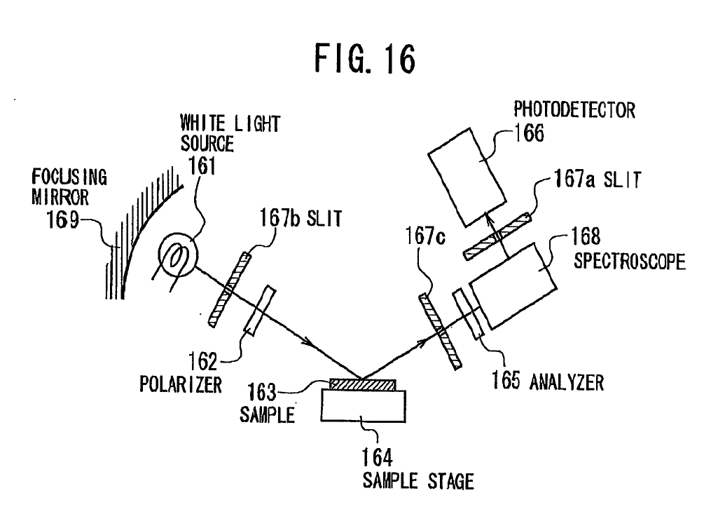

An evaluation system used for performing a method of evaluating an optically anisotropic structure according to a sixth example of the invention is schematically shown in FIG. 16

As seen from FIG. 16, the evaluation system comprises a white light source (i.e., halogen lamp) 161, a polarizer 162, a movable sample stage 164 on which a sample 163 (i.e., optically anisotropic structure) is placed, an analyzer 165, a photodetector (i.e., photodiode) 166, three slits 167a, 167b, and 167c, a spectroscope 168 (i.e., diffraction grating), and a focusing mirror 169.

The light source 161 emits white light as incident light toward the sample 163 placed on the stage 164 by way of the slit 167b and the polarizer 162, thereby generating reflected light. The focusing mirror 169 reflects the white light and focuses it toward the sample 163. The reflected light enters the photodetector 166 by way of the slit 167c, the analyzer 165, the spectroscope 168, and the slit 167a.

The white reflected light is converted to monochromic light by the spectroscope 168. The monochromic light thus generated enters the photodetector 166.

The polarizer 162 allows selectively a p-polarized component or s-polarized component of the incident light to pass through the same. The reflected light contains not only a p-polarized component but also a s-polarized component. The analyzer 165 allows selectively the s- or p-polarized component of the reflected light to pass through the same. In other words, the analyzer 165 allows selectively a polarized component of the reflected light perpendicular to the selected component of the incident light. The photodetector 166 detects the polarized component of the reflected light that has passed through the analyzer 165 and the spectroscope 168 and then, measures its intensity.

### Seventh Example

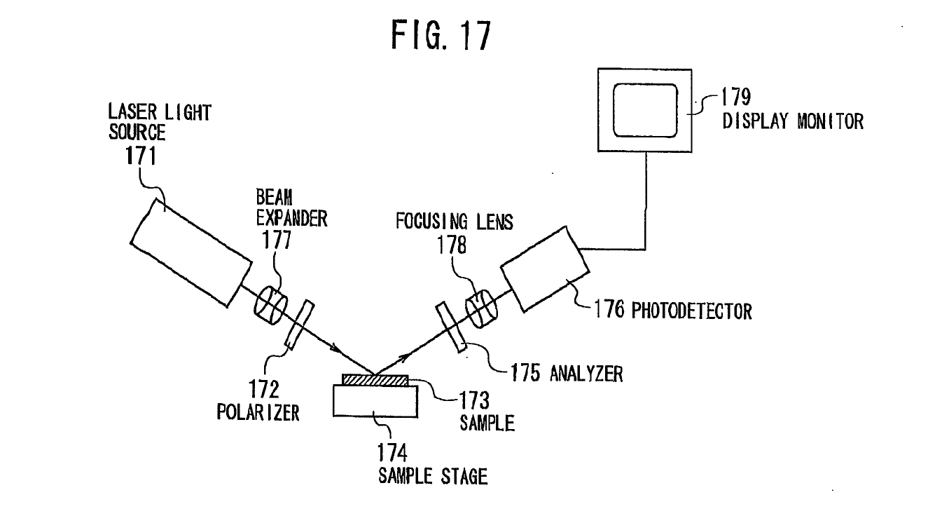

An evaluation system used for performing a method of evaluating an optically anisotropic structure according to a seventh example of the invention is schematically shown in FIG. 17.

As seen from FIG. 17, the evaluation system comprises a laser light source (i.e., He—Ne laser) 171, a polarizer 172, a movable sample stage 174 on which a sample 173 (i.e., optically anisotropic structure) is placed, an analyzer 175, a photodetector (i.e., photodiode) 176, a beam expander 177, a focusing lens 178, and a display monitor 179.

The light source 171 emits monochrome light as incident light toward the sample 173 placed on the stage 174 by way of the beam expander 177 and the polarizer 172, thereby generating reflected light. Due to the beam expander 177, the beam of the laser light is expanded to have a specific desired diameter. The reflected light enters the photodetector 176 by way of the analyzer 175 and the focusing lens 178. The focusing lens 178 serves to decrease the expanded beam diameter of the reflected light to a specific desired value.

The polarizer 172 and the analyzer 175 have the same functions as those in the sixth example.

The photodetector 176 is a two-dimensional position-sensitive optical detector, such as a two-dimensional CCD image sensor, an image multiplier tube, and so on.

The monitor 179 is used to display the measured distribution of the intensity of the reflected light by the photodetector 176.

In the first to seventh examples, when it is judged whether or not the sample 173 is good on the basis of the result about the optical anisotropy, the maximum and minimum values of the measurement result are preferably used. As the maximum and minimum values, the maximum and minimum peaks or the average value in their vicinity may be used.

If the sample has weak anisotropy, the detection sensitivity can be raised by adding slightly one of a p-polarized component and a s-polarized component to the other of the p-polarized component and the s-polarized component.

### Eighth Example

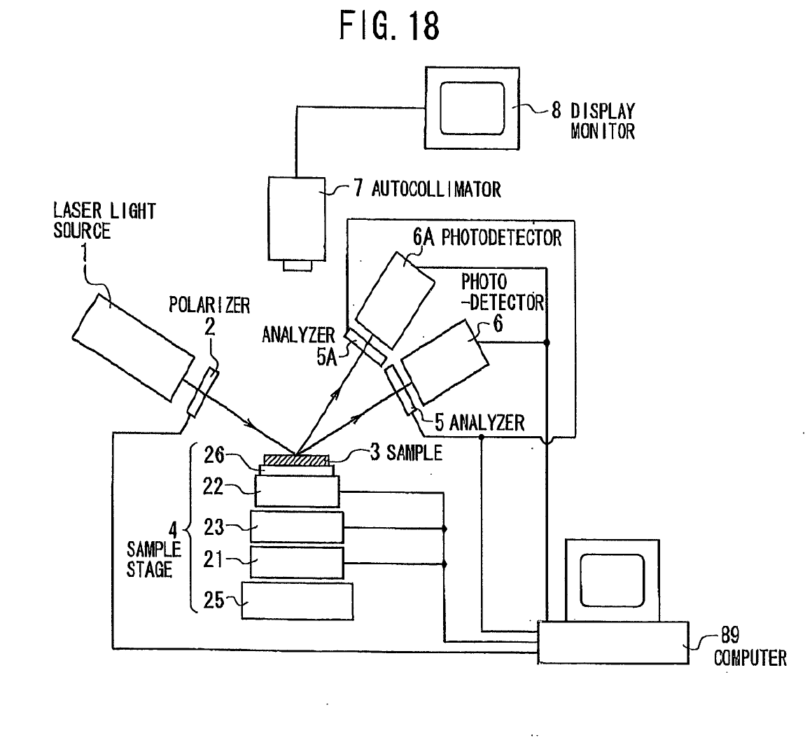

An evaluation system used for performing a method of evaluating an optically anisotropic structure according to an eighth example of the invention is schematically shown in FIG. 18.

The system in FIG. 18 has the same configuration as that of the system as shown in FIG. 8 except that an analyzer 5A and a photodetector 6A are additionally provided. Therefore, the explanation about the same configuration is omitted here by attaching the same reference numerals as those in FIG. 8 for the sake of simplification.

In this method, the intensity of the polarized component of the reflected light is measured with the two photodetectors 6 and 6A arranged in such a way that incident orientation of the reflected light to the detectors 6 and 6A is different from each other. Thus, the in-plane distribution and orientation of optical anisotropy of the sample 3 is determined.

### Ninth Example

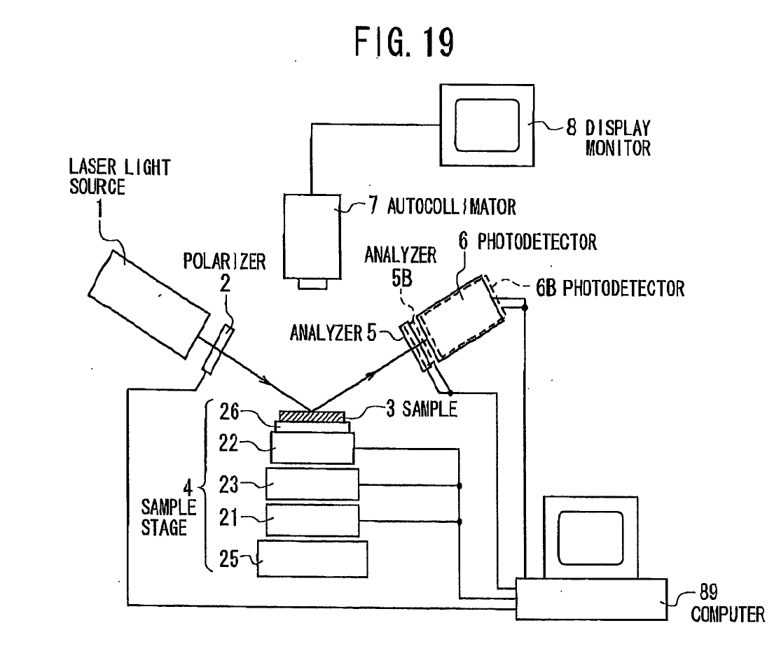

An evaluation system used for performing a method of evaluating an optically anisotropic structure according to a ninth example of the invention is schematically shown in FIG. 19.

The system in FIG. 19 has the same configuration as that of the system as shown in FIG. 8 except that an analyzer 59 and a photodetector 6B are additionally provided. Therefore, the explanation about the same configuration is omitted here by attaching the same reference numerals as those in FIG. 8 for the sake of simplification.

The two photodetectors 6 and 6A are aligned in a specific horizontal direction. The two analyzers 5 and 5A are aligned in a specific horizontal direction as well.

In this method, the intensity of the polarized component of the reflected light is measured with the detectors 6 and 6A aligned in the horizontal direction while the sample 3 is moved in parallel to the detectors 6 and 6A. Thus, the in-plane distribution of optical anisotropy of the sample 3 is determined.

### VARIATIONS

It is needless to say that the invention is not limited to the above-described examples Instead of the polyimide layer (i.e., the alignment layer) formed on the glass substrate, any other optically anisotropic structure may be used as the sample. For example, the structure may be a multilayer structure. In other words, the invention is applicable to not only an optically anisotropic structure but also an optically anisotropic multiplayer structure, such as a glass substrate assembly of a LCD device, where the glass substrate assembly comprises a glass substrate, a silicon dioxide layer, a polysilicon layer, an aluminum layer, a STO layer, and a polyimide layer, all of which are stacked in this order on the surface of the glass substrate.

When an actual glass substrate assembly of an LCD device is used as the sample, to avoid the effect by the unavoidable damages on the glass substrate it is preferred that the sample stage is made of a material having a refractive index equivalent to that of the glass substrate of the sample. Also, to improve the adhesion state between the sample and the sample stage, it is more preferred that a viscous oil or grease having a refractive index equivalent to that of the glass substrate of the sample is additionally inserted between the sample and the sample stage.

If reflected light generated by a part with high reflection efficiency of the sample (e.g., aluminum wiring layer) is used for measuring the intensity of the reflected light, there arises an additional advantage that the detection sensitivity is improved.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A method or evaluating an optically anisotropic structure, the method comprising the steps of:
(a) irradiating incident light containing a first polarized component to an optically anisotropic structure, generating reflected light containing a second polarized component due to reflection by the structure;
the first polarized component being one of a s-polarized component and a p-polarized component;
the second polarized component being one of a s-polarized component and a p-polarized component and different from the first polarized component; and
(b) measuring intensity of the second polarized component of the reflected light, determining optical anisotropy of the structure

2. The method according to claim 1, wherein the structure is translated with respect to the structure in the step (b), thereby measuring in-plane distribution of optical anisotropy of the structure.

3. The method according to claim 1, wherein the structure is turned around an axis in the step (b), thereby determining orientation of principal dielectric constant coordinate axes of the structure

4. The method according to claim 1, wherein the intensity of the second polarized component of the reflected light is measured with detectors aligned in a direction while the structure is moved in parallel to the detectors in the step (b), thereby determining in-plane distribution of optical anisotropy of the structure.

5. The method according to claim 1, wherein the intensity of the second polarized component of the reflected light is measured with detectors arranged in such a way that incident orientation of the reflected light to the detectors is different from each other in the step (b), thereby determining in-plane distribution and orientation of optical anisotropy of the structure

6. The method according to claim 1, wherein the intensity of the second polarized component of the reflected light is measured with detectors arranged in parallel while the structure is translated parallel to the detectors in the step (b), thereby determining in-plane distribution of optical anisotropy of the structure.

7. The method according to claim 1, wherein the incident light is irradiated to the structure at an incident angle in such a way that the second polarized component of the reflected light is maximized in the step (a).

8. The method according to claim 1, wherein the incident light is irradiated to the structure at an incident angle and an incident orientation in such a way that the second polarized component of the reflected light is maximized in the step (a).

9. The method according to claim 1, wherein the incident light having a constant cross-section is used in the step (a);
and wherein the intensity of the second polarized component of the reflected light is measured with a two-dimensional optical detector.

10. The method according to claim 1, wherein a polarizer for generating the incident light and an analyzer for selecting the second component of the reflected light are additionally used.

11. A system for evaluating an optically anisotropic structure, comprising:
(a) an incident light irradiator for irradiating incident light containing a first polarized component to an optically anisotropic structure, generating reflected light containing a second polarized component due to reflection by the structure;
the first polarized component being one of a s-polarized component and a p-polarized component;
the second polarized component being one of a s-polarized component and a p-polarized component and different from the first polarized component; and
(b) a measuring subsystem for measuring intensity of the second polarized component of the reflected light, determining optical anisotropy of the structure.

12. The system according to claim 11, further comprising a sample stage on which structure is placed;
wherein the stage is designed to be translated in a desired direction, thereby measuring in-plane distribution of optical anisotropy of the structure

13. The system according to claim 11, further comprising a sample stage on which structure is placed;
wherein the stage is designed to be turned around an axis, thereby determining orientation of principal dielectric constant coordinate axes of the structure.

14. The system according to claim 12, wherein the measuring subsystem comprises detectors for measuring the intensity of the second polarized component of the reflected light;
the detectors being aligned in a direction;
and wherein the detectors are used to measure the intensity of the second polarized component of the reflected light while the structure is moved in parallel to the detectors, thereby determining in-plane distribution of optical anisotropy of the structure.

15. The system according to claim 11, wherein the measuring subsystem comprises detectors for measuring the intensity of the second polarized component of the reflected light;
the detectors being arranged in such a way that incident orientation of the reflected light to the detectors is different from each other;
and wherein the detectors are used to measure the intensity of the second polarized component of the reflected light, thereby determining in-plane distribution and orientation of optical anisotropy of the structure.

16. The system according to claim 12, wherein the measuring subsystem comprises detectors arranged in parallel;
and wherein the detectors are used to measure the intensity of the second polarized component of the reflected light while the structure is moved in parallel to the detectors thereby determining in-plane distribution of optical anisotropy of the structure.

17. The system according to claim 11, wherein the incident light irradiator irradiates the incident light to the structure at an incident angle in such a way that the second polarized component of the reflected light is maximized.

18. The system according to claim 11, wherein the incident light irradiator irradiates the incident light to the structure at an incident angle and an incident orientation in such a way that the second polarized component of the reflected light is maximized.

19. The system according to claim 11, wherein the measuring subsystem comprises a two-dimensional optical detector and the incident light has a constant cross-section;
and wherein the intensity of the second polarized component of the reflected light is measured with the two-dimensional optical detector.

20. The system according to claim 11, wherein the incident light irradiator comprises a polarizer for generating the incident light, and the measuring subsystem comprises an analyzer for selecting the second component of the reflected light.

21. A method of measuring in-plane optical anisotropy distribution of an optically anisotropic structure, the method comprising the steps of:
(a) inputting measuring condition;
the measuring condition including coordinate data about an initial position;
(b) moving an optically anisotropic structure based on the coordinate data about an initial position;
(c) adjusting inclination of the structure;
(d) finding an angle at which detected intensity of light is maximized;
(e) matching orientation of the structure with an orientation at which the detected intensity of light is maximized; and
(f) measuring intensity of the reflected light at specific positions defined by the measuring condition, thereby measuring in-plane optical anisotropy distribution of the structure.

22. A computer program product having a computer readable medium and a computer program recorded thereon, the computer program being operable to evaluate an optically anisotropic structure. This product comprises:
(a) code that inputs measuring condition;
the measuring condition including coordinate data about an initial position;
(b) code that moves an optically anisotropic structure based on the coordinate data about an initial position;
(c) code that adjusts inclination of the structure;
(d) code that finds an angle at which detected intensity of light is maximized;
(e) code that matches orientation of the structure with an orientation at which the detected intensity of light is maximized; and
(f) code that measures intensity of the reflected light at specific positions defined by the measuring condition, thereby measuring in-plane optical anisotropy distribution of the structure.
